(19) United States
(12) Patent Application Publication
(10) Pub. No.: US 2015/0068965 A1
(43) Pub. Date: Mar. 12, 2015

(54) OIL FILTER NUT

(71) Applicants: James Harris, Gallipolis, OH (US); Jennifer Harris, Gallipolis, OH (US)

(72) Inventors: James Harris, Gallipolis, OH (US); Jennifer Harris, Gallipolis, OH (US)

(21) Appl. No.: 14/022,467

(22) Filed: Sep. 10, 2013

(51) Int. Cl. B01D 35/00

(52) U.S. Cl. CPC B01D 35/005
USPC 210/232

(57) ABSTRACT

A system for securing an oil filter comprising: a nut; and an oil filter, where the nut secures the oil filter over a top surface of the oil filter. In one particular embodiment, the nut is 14 mm is length and may be turned clockwise to secure the filter.

### BACKGROUND OF THE INVENTION

1. Field of Invention

The present invention relates to an alternative system to fasten and attach an oil filter.

2. Description of Related Art

A typical oil filter is a device that is designed to remove contaminants from engine oil or in some cases transmission oil, lubricating oil or hydraulic oil. Oil filters are primarily used in internal combustion engines for motor vehicles, further oil filters are used in boats, aircraft and other general vessels. The typical oil filter is contained in a canister and is usually screwed into a position to allow the flow of oil through the filter while the oil is being used in the vehicle. The filters normally require a special wrench or tool to remove and install the filter. The use of the special tool can be a nuisance for some consumers who prefer working on their vehicle and performing their own oil changes. Consequently, it would be advantageous to have a device or system that afforded a more efficient manner to remove and/or replace the oil filter.

### SUMMARY OF THE INVENTION

The present invention relates to a system for securing an oil filter comprising: a nut; and an oil filter, where the nut secures the oil filter over a top surface of the oil filter. In one particular embodiment, the nut is 14 mm is length and may be turned clockwise to secure the filter.

### BRIEF DESCRIPTION OF DRAWINGS

FIG. 1 depicts an oil filter and a nut in accordance with the present invention.

### DETAILED DESCRIPTION

The present invention relates to an oil filter nut and fastening system that secures an oil filter into place. The present invention includes use of a six-sided nut that is placed over the top surface of an oil filter to secure the oil filter into place. The nut in the preferred embodiment is 14 millimeters in length. The nut simply goes over the top of the filter and provides an attachment means to secure the filter into place. The oil filter is secured by using a nut and then eliminates the need for the individual to use a specialized oil filter wrench to remove the oil filter.

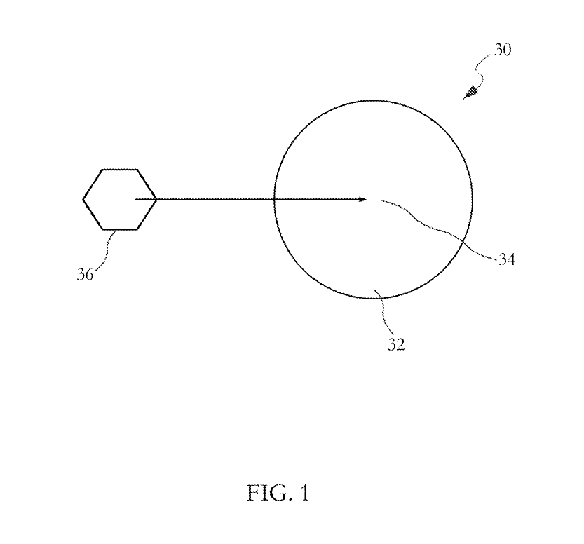

In reference to FIG. 1, Nut 36 is depicted for use with the present invention. The Nut 36 is assembled onto a Filter 30. The Nut 36 is positioned at Position 34 shown on the top surface of the Filter 30 and secures the Filter 30 into place. The Nut 36 secures the filter 30 and enables an effortless movement of the filter into its operational position on a motor vehicle. The Nut 36 is positioned directly at the center of the Oil Filter 30 as shown in FIG. 1 in Position 34. Once in position, the Nut 36 may be turned clockwise to secure the Oil Filter 30 into place. The instant invention has been shown and described in what it considers to be the most practical and preferred embodiments. It is recognized, however, that departures may be made there from within the scope of the invention and that obvious modifications will occur to a person skilled in the art.

1. A system for securing an oil filter comprising:
a. a nut, where the nut is 14 mm in length; and
b. an oil filter, where the nut secures the oil filter over a top surface of the oil filter.

2. (canceled)

3. The system according to claim 1, where the nut is turned clockwise to secure the filter.
